(19) United States
(12) Patent Application Publication
(10) Pub. No.: US 2017/0274432 A1
(43) Pub. Date: Sep. 28, 2017

(54) NON-ORIENTED ELECTRICAL STEEL SHEET AND MANUFACTURING METHOD THEREOF

(71) Applicant: JFE STEEL CORPORATION, Tokyo (JP)

(72) Inventors: Tomoyuki Okubo, Chiyoda-ku, Tokyo (JP); Yoshihiko Oda, Chiyoda-ku, Tokyo (JP); Hiroaki Nakajima, Chiyoda-ku, Tokyo (JP)

(73) Assignee: JFE STEEL CORPORATION, Tokyo (JP)

(21) Appl. No.: 15/506,140

(22) PCT Filed: Aug. 18, 2015
(86) PCT No.: PCT/JP2015/004104

§ 371 Date: Feb. 23, 2017

(30) Foreign Application Priority Data
Aug. 27, 2014 (JP) 2014-172993

(51) Int. Cl. B21B 3/02; C21D 8/12; C22C 38/00; C22C 38/02; C22C 38/04; H01F 1/16; C22C 38/06

(52) U.S. Cl. CPC B21B 3/02; H01F 1/16; C21D 8/1222; C21D 8/1233; C22C 38/06; C22C 38/02; C22C 38/04; C22C 38/001

(57) ABSTRACT

A non-oriented electrical steel sheet with lower iron loss than conventional non-oriented electrical steel sheets is provided. The non-oriented electrical steel sheet has a chemical composition containing, in mass %: C: 0.05% or less; Si: 0.1% or more and 7.0% or less; Al: 0.1% or more and 3.0% or less; Mn: 0.03% or more and 3.0% or less; P: 0.2% or less; S: 0.005% or less; N: 0.005% or less; and O: 0.01% or less, and further optionally containing a predetermined amount of one or more of Sn, Sb, Ca, Mg, REM, Cr, Ti, Nb, V, and Zr, with the balance consisting of Fe and incidental impurities, wherein a sheet thickness is less than 0.30 mm, and arithmetic mean roughness Ra of a steel substrate surface at cutoff wavelength λc=20 μm is 0.2 μm or less.

### TECHNICAL FIELD

The disclosure relates to a non-oriented electrical steel sheet suitable for an iron core material of a motor that rotates at relatively high speed such as a drive motor of a HEV or EV, and a manufacturing method thereof.

### BACKGROUND

Non-oriented electrical steel sheets are materials used as iron cores of motors or transformers, and are required to have low iron loss to improve the efficiency of these electrical devices. Iron loss can be effectively reduced by increasing specific resistance or reducing sheet thickness. However, increasing specific resistance involves an increase in alloy cost, and reducing sheet thickness involves an increase in rolling and annealing cost. A new iron loss reduction technique is therefore desired.

As an iron loss reduction technique other than increasing specific resistance or reducing sheet thickness, it is known that, in a grain-oriented electrical steel sheet, hysteresis loss can be reduced by removing a forsterite film and smoothing the surface. This is because a decrease in surface roughness facilitates domain wall displacement. JP 2009-228117 A (PTL 1) proposes a technique of limiting the surface roughness of a steel sheet before final annealing to 0.3 μm or less in arithmetic mean roughness Ra and using an alumina separator as an annealing separator.

In a non-oriented electrical steel sheet, on the other hand, the influence of surface roughness on iron loss is considered less significant. JP 2001-192788 A (PTL 2) and JP 2001-279403 A (PTL 3) each propose a technique of reducing the surface roughness of a non-oriented electrical steel sheet. PTL 2 describes a non-oriented electrical steel sheet whose steel sheet surface has Ra of 0.5 μm or less to suppress a decrease in stacking factor. PTL 3 describes a non-oriented electrical steel sheet that contains 1.5 mass % or more and 20 mass % or less Cr and whose steel sheet surface has Ra of 0.5 μm or less to reduce high-frequency iron loss.

### CITATION LIST

### Patent Literatures

PTL 1: JP 2009-228117 A

PTL 2: JP 2001-192788 A

PTL 3: JP 2001-279403 A

### SUMMARY

### Technical Problem

However, the technique proposed in PTL 1 relates to a grain-oriented electrical steel sheet, and PTL 1 does not provide any suggestion about reducing the iron loss of a non-oriented electrical steel sheet. The technique proposed in PTL 2 relates to a non-oriented electrical steel sheet, but is intended to improve the stacking factor and not intended to reduce the iron loss. The technique proposed in PTL 3 is intended to reduce the high-frequency iron loss of a non-oriented electrical steel sheet, but a greater iron loss reduction is desired.

It could therefore be helpful to provide a non-oriented electrical steel sheet with lower iron loss than conventional non-oriented electrical steel sheets, and a manufacturing method thereof.

### Solution to Problem

We examined the influence of surface roughness as follows, and acquired a new idea on surface roughness control. In the case of applying an external magnetic field to a steel sheet having surface roughness to displace its domain wall, the magnetostatic energy of the surface increases with the domain wall displacement, and so the domain wall is subjected to a restoring force. The restoring force is not only affected by the depth of the roughness, but also affected by the wavelength of the roughness. In detail, in the case where the roughness changes at a larger wavelength than the domain wall displacement distance, even when the domain wall is displaced, the change of magnetostatic energy is small, and accordingly the restoring force exerted on the domain wall is small. In the case where the roughness changes at a smaller wavelength than the domain wall displacement distance (i.e. fine roughness), on the other hand, the restoring force exerted on the domain wall is large.

A grain-oriented electrical steel sheet has a grain size of about 10 mm and a domain width of about 1 mm, and so the domain wall displacement distance is about 1 mm. A non-oriented electrical steel sheet has a grain size of about 100 μm, and a domain width and domain wall displacement distance of about 10 μm, which are very small. We accordingly considered that, to reduce the iron loss of the non-oriented electrical steel sheet, it is necessary to evaluate fine roughness obtained by removing waviness on the long-wavelength side at a cutoff wavelength of about several ten μm and reduce the fine roughness. Such fine roughness is hereafter also referred to as “microroughness”.

PTL 1 describes a reduction in Ra of the steel sheet surface of a grain-oriented electrical steel sheet, and PTL 2 and PTL 3 describe a reduction in Ra of the steel sheet surface of a non-oriented electrical steel sheet. However, these techniques have no clear cutoff wavelength, and are not concerned with the aforementioned microroughness. Our focus is on microroughness of a smaller wavelength than the domain wall displacement distance. The technical idea is thus fundamentally different from those of the conventional techniques.

As a result of conducting intensive study based on the idea stated above, we discovered that, while hysteresis loss increases when the sheet thickness of a non-oriented electrical steel sheet is less than 0.30 mm in a typical manufacturing method, this hysteresis loss increase is suppressed by reducing microroughness.

We provide the following:

(1) A non-oriented electrical steel sheet having a chemical composition containing (consisting of), in mass %:

C: 0.05% or less;

Si: 0.1% or more and 7.0% or less;

Al: 0.1% or more and 3.0% or less;

Mn: 0.03% or more and 3.0% or less;

P: 0.2% or less;

S: 0.005% or less;

N: 0.005% or less; and

O: 0.01% or less,

with the balance consisting of Fe and incidental impurities,

wherein a sheet thickness is less than 0.30 mm, and

arithmetic mean roughness Ra of a steel substrate surface at cutoff wavelength λc=20 μm is 0.2 μm or less.

(2) The non-oriented electrical steel sheet according to the foregoing (1),

wherein the chemical composition contains, in mass %, one or more of Sn and Sb: 0.01% or more and 0.2% or less in total.

(3) The non-oriented electrical steel sheet according to the foregoing (1) or (2),

wherein the chemical composition contains, in mass %, one or more of Ca, Mg, and REM: 0.0005% or more and 0.010% or less in total.

(4) The non-oriented electrical steel sheet according to any one of the foregoing (1) to (3),

wherein the chemical composition contains, in mass %, Cr: 0.1% or more and 20% or less.

(5) The non-oriented electrical steel sheet according to any one of the foregoing (1) to (4),

wherein the chemical composition contains, in mass %, one or more of Ti, Nb, V, and Zr: 0.01% or more and 1.0% or less in total.

(6) A manufacturing method of a non-oriented electrical steel sheet, including:

heating a steel slab having the chemical composition according to any one of the foregoing (1) to (5);

hot rolling the steel slab into a hot rolled steel sheet;

optionally hot band annealing the hot rolled steel sheet;

cold rolling the hot rolled steel sheet once or twice or more with intermediate annealing in between, into a cold rolled steel sheet whose sheet thickness is less than 0.30 mm; and

final annealing the cold rolled steel sheet,

wherein arithmetic mean roughness Ra of a roll surface in a final pass of last cold rolling at cutoff wavelength λc=20 μm is 0.2 μm or less.

### Advantageous Effect

It is thus possible to provide a non-oriented electrical steel sheet with iron loss reduced by reducing the microroughness of the steel substrate surface, without significantly limiting the steel components. It is also possible to provide a method of advantageously manufacturing a non-oriented electrical steel sheet with iron loss reduced by reducing the microroughness of the steel substrate surface.

### BRIEF DESCRIPTION OF THE DRAWINGS

In the accompanying drawings:

FIG. 1 is a graph illustrating the relationship between the arithmetic mean roughness Ra (cutoff wavelength λc=20 μm) of the steel substrate surface and the hysteresis loss Wh_{10/50} in various sheet thicknesses.

### DETAILED DESCRIPTION

(Non-Oriented Electrical Steel Sheet)

The following describes a non-oriented electrical steel sheet according to one of the disclosed embodiments. The reasons for limiting the chemical composition of steel are described first. In this description, “%” indicating the content of each element denotes “mass %”.

C: 0.05% or less

C can be used to strengthen the steel. When the C content exceeds 0.05%, working is difficult. The upper limit of the C content is therefore 0.05%. In the case of not using C for strengthening, the C content is preferably 0.005% or less to suppress magnetic aging.

Si: 0.1% or more and 7.0% or less

Si, when 0.1% or more is added, has an effect of increasing the specific resistance of the steel to reduce iron loss. When the Si content exceeds 7.0%, however, iron loss increases. The Si content is therefore 0.1% or more and 7.0% or less. The Si content is preferably 1.0% or more and 5.0% or less, in terms of the balance between iron loss and workability.

Al: 0.1% or more and 3.0% or less

Al, when 0.1% or more is added, has an effect of increasing the specific resistance of the steel to reduce iron loss. When the Al content exceeds 3.0%, however, casting is difficult. The Al content is therefore 0.1% or more and 3.0% or less. The Al content is preferably 0.3% or more and 1.5% or less.

Mn: 0.03% or more and 3.0% or less

Mn, when 0.03% or more is added, prevents the hot shortness of the steel. It also has an effect of increasing the specific resistance to reduce iron loss. When the Mn content exceeds 3.0%, however, iron loss increases. The Mn content is therefore 0.03% or more and 3.0% or less. The Mn content is preferably 0.1% or more and 2.0% or less.

P: 0.2% or less

P can be used to strengthen the steel. When the P content exceeds 0.2%, however, the steel becomes brittle and working is difficult. The P content is therefore 0.2% or less. The P content is preferably 0.01% or more and 0.1% or less.

S: 0.005% or less

When the S content exceeds 0.005%, precipitates such as MnS increase and grain growth degrades. The upper limit of the S content is therefore 0.005%. The S content is preferably 0.003% or less.

N: 0.005% or less

When the N content exceeds 0.005%, precipitates such as AlN increase and grain growth degrades. The upper limit of the N content is therefore 0.005%. The N content is preferably 0.003% or less.

O: 0.01% or less

When the O content exceeds 0.01%, oxides increase and grain growth degrades. The upper limit of the O content is therefore 0.01%. The O content is preferably 0.005% or less.

In addition to the aforementioned components, the following components may be added.

Sn, Sb: 0.01% or more and 0.2% or less in total

Sn and/or Sb, when 0.01% or more is added, have an effect of reducing [111] crystal grains in the recrystallization texture to improve magnetic flux density. They also have an effect of preventing nitriding and oxidation in final annealing or stress relief annealing to suppress an increase in iron loss. When the total content of Sn and/or Sb exceeds 0.2%, however, the effects saturate. The total content of Sn and/or Sb is therefore 0.01% or more and 0.2% or less. The total content of Sn and/or Sb is preferably 0.02% or more and 0.1% or less.

Ca, Mg, REM: 0.0005% or more and 0.010% or less in total

Ca, Mg, and/or REM, when 0.0005% or more is added, have an effect of coarsening sulfides to improve grain growth. When the total content of Ca, Mg, and/or REM exceeds 0.010%, however, grain growth degrades. The total content of Ca, Mg, and/or REM is therefore 0.0005% or more and 0.010% or less. The total content of Ca, Mg, and/or REM is preferably 0.001% or more and 0.005% or less.

Cr: 0.1% or more and 20% or less

Cr, when 0.1% or more is added, has an effect of increasing the specific resistance of the steel to reduce iron loss. A large amount of Cr can be added because of low steel hardness. When the Cr content exceeds 20%, however, decarburization is difficult, and carbides precipitate and cause an increase in iron loss. The Cr content is therefore 0.1% or more and 20% or less. The Cr content is preferably 1.0% or more and 10% or less.

Ti, Nb, V, Zr: 0.01% or more and 1.0% or less in total

Ti, Nb, V, and/or Zr are carbide- or nitride-forming elements. When the total content of Ti, Nb, V, and/or Zr is 0.01% or more, the strength of the steel can be enhanced. When the total content of Ti, Nb, V, and/or Zr exceeds 1.0%, however, the effect saturates. The total content of Ti, Nb, V, and/or Zr is therefore 0.01% or more and 1.0% or less. The total content of Ti, Nb, V, and/or Zr is preferably 0.1% or more and 0.5% or less. In the case of not using Ti, Nb, V, and/or Zr for strengthening, the total content of Ti, Nb, V, and/or Zr is preferably 0.005% or less to improve grain growth.

The balance other than the aforementioned elements is Fe and incidental impurities.

It is important that, in the non-oriented electrical steel sheet in this embodiment, the arithmetic mean roughness Ra of the steel substrate surface at cutoff wavelength λc=20 μm is 0.2 μm or less. By reducing fine roughness of a smaller wavelength than the domain wall displacement distance in this way, hysteresis loss can be reduced. The arithmetic mean roughness Ra is preferably 0.1 μm or less.

The measurement of the surface roughness is performed as defined in JIS B 0601, JIS B 0632, JIS B 0633, and JIS B 0651. Since the measurement is performed on the steel substrate surface, if any coating is applied to the steel substrate surface, the coating is removed by boiled alkali or the like. A measurement machine capable of accurately detecting microroughness of several μm or less in wavelength is selected to measure the surface roughness. A typical stylus-type surface roughness meter has a stylus tip radius of several μm, and so is not suitable to detect microroughness. Accordingly, a three-dimensional scanning electron microscope is used to measure the arithmetic mean roughness Ra in the disclosure. To detect microroughness, the reference length and the cutoff wavelength (cutoff value) λc are set to 20 μm. The cutoff ratio λc/λs is not particularly designated, but is desirably 100 or more. The measurement is performed with cutoff ratio λc/λs of 100 in the disclosure. The measurement directions are the rolling direction and the direction orthogonal to the rolling direction. The measurement is performed three times in each direction, and the mean value is used.

Microroughness obtained by, for example, a typical stylus-type surface roughness meter does not affect the magnetic property, and so is not particularly limited. To improve the stacking factor, it is desirable that the arithmetic mean roughness Ra of the steel substrate surface obtained at cutoff wavelength λc=0.8 mm and cutoff ratio λc/λs=300 is 0.5 μm or less.

In this embodiment, the sheet thickness is less than 0.30 mm. In the case where the sheet thickness is less than 0.30 mm, the iron loss reduction effect by limiting the arithmetic mean roughness Ra of the steel substrate surface at cutoff wavelength λc=20 μm to 0.2 μm or less is achieved. The sheet thickness is preferably 0.25 mm or less, and more preferably 0.15 mm or less. When the sheet thickness is less than 0.05 mm, the manufacturing cost increases. Accordingly, the sheet thickness is preferably 0.05 mm or more.

(Manufacturing Method of Non-Oriented Electrical Steel Sheet)

The following describes a manufacturing method of a non-oriented electrical steel sheet according to one of the disclosed embodiments. Molten steel adjusted to the aforementioned chemical composition may be formed into a steel slab by typical ingot casting and blooming or continuous casting, or a thin slab or thinner cast steel with a thickness of 100 mm or less by direct casting.

The steel slab is then heated by a typical method, and hot rolled into a hot rolled steel sheet.

The hot rolled steel sheet is then subjected to hot band annealing according to need. The hot band annealing is intended to prevent ridging or improve magnetic flux density, and may be omitted if unnecessary. A preferable condition is 900° C. to 1100° C.×1 sec to 300 sec in the case of using a continuous annealing line, and 700° C. to 900° C.×10 min to 600 min in the case of using a batch annealing line.

The hot rolled steel sheet is then pickled, and cold rolled once or twice or more with intermediate annealing in between, into a cold rolled steel sheet with the final sheet thickness. The final sheet thickness is less than 0.30 mm.

A preferable method of limiting the arithmetic mean roughness Ra of the steel substrate surface at cutoff wavelength λc=20 μm to 0.2 μm or less is to adjust the surface roughness of the rolling mill rolls in the final pass of the last cold rolling. In this embodiment, the arithmetic mean roughness Ra of the roll surface in the final pass of the last cold rolling at cutoff wavelength λc=20 μm is 0.2 μm or less. At least the final pass is preferably dry rolling, to efficiently transfer the roll surface to the steel. The surface of the cold rolled steel sheet can be smoothed in this way. In the case of not smoothing the steel substrate surface in the cold rolling, a step such as chemical polishing or electropolishing may be added after the cold rolling or final annealing, to set the arithmetic mean roughness Ra of the steel substrate surface at cutoff wavelength λc=20 μm to 0.2 μm or less. In terms of manufacturing cost, however, the steel substrate surface is preferably smoothed during the cold rolling.

After the final cold rolling, the cold rolled steel sheet is subjected to final annealing. If the steel sheet surface is oxidized or nitrided in the final annealing, the magnetic property degrades significantly. To prevent oxidation, the annealing atmosphere is preferably a reducing atmosphere. For example, it is preferable to use a N₂-H₂ mixed atmosphere with a H₂ concentration of 5% or more, and decrease the dew point to control PH₂O/PH₂ to 0.05 or less. To prevent nitriding, the N₂ partial pressure of the furnace atmosphere is preferably 95% or less, and more preferably 85% or less. Adding one or more of Sn and Sb in an amount of 0.01% or more and 0.2% or less in total to the steel is particularly effective in suppressing oxidation and nitriding. A preferable annealing condition is 700° C. to 1100° C.×1 sec to 300 sec. The annealing temperature may be increased in the case of placing importance on iron loss, and decreased in the case of placing importance on strength.

After the final annealing, insulating coating is applied to the steel sheet surface according to need, thus obtaining a product sheet (non-oriented electrical steel sheet). The insulating coating may be well-known coating. For example, inorganic coating, organic coating, and inorganic-organic mixed coating may be selectively used depending on purpose.

The other manufacturing conditions may comply with a typical manufacturing method of a non-oriented electrical steel sheet.

### EXAMPLES

### Example 1

A steel slab containing C: 0.0022%, Si: 3.25%, Al: 0.60%, Mn: 0.27%, P: 0.02%, S: 0.0018%, N: 0.0021%, O: 0.0024%, and Sn: 0.06% with the balance consisting of Fe and incidental impurities was obtained by steelmaking, heated at 1130° C. for 30 minutes, and then hot rolled into a hot rolled steel sheet. The hot rolled steel sheet was subjected to hot band annealing of 1000° C.×30 sec, and further cold rolled into a cold rolled steel sheet of 0.15 mm to 0.30 mm in sheet thickness. The obtained cold rolled steel sheet was subjected to final annealing of 1000° C.×10 sec in an atmosphere of H₂:N₂=30:70 with a dew point of −50° C., and then insulating coating was applied to obtain a product sheet.

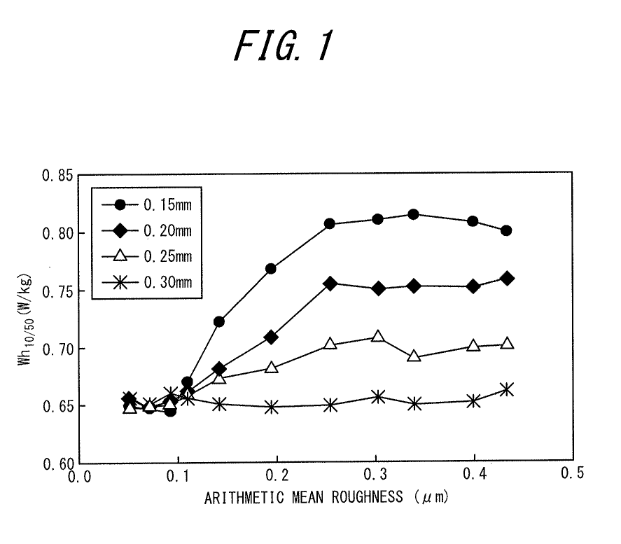

Here, the microroughness of the steel substrate surface of the product sheet was changed by adjusting the surface roughness of the rolling mill rolls in the final pass of the cold rolling. Test pieces of 280 mm×30 mm were collected from the obtained product sheet, and direct-current magnetic measurement was performed by Epstein testing to measure hysteresis loss Wh_{10/50} with Bm=1.0 T and f=50 Hz. Moreover, after removing the insulating coating of the product sheet by boiled alkali, surface shape measurement for 100 μm×100 μm was conducted with an accelerating voltage of 5 kV using 3D-SEM (ERA-8800FE) made by Elionix Inc., and the arithmetic mean roughness Ra of the steel substrate surface at cutoff wavelength λc=20 μm was measured under the aforementioned condition. FIG. 1 illustrates the results. The results indicate that hysteresis loss was low in the disclosed range. In the case where Ra of the roll surface in the final pass of the cold rolling at cutoff wavelength λc=20 μm was 0.2 μm or less, the arithmetic mean roughness Ra of the steel substrate surface was 0.2 μm or less.

### Example 2

A steel slab containing the components shown in Table 1 with the balance consisting of Fe and incidental impurities was obtained by steelmaking, heated at 1100° C. for 30 minutes, and then hot rolled into a hot rolled steel sheet. The hot rolled steel sheet was subjected to hot band annealing of 980° C.×30 sec, and further cold rolled into a cold rolled steel sheet of 0.15 mm in sheet thickness. The obtained cold rolled steel sheet was subjected to final annealing of 980° C.×10 sec in an atmosphere of H₂:N₂=20:80 with a dew point of −40° C., and then insulating coating was applied to obtain a product sheet.

Here, the microroughness of the steel substrate surface of the product sheet was changed by adjusting the surface roughness of the rolling mill rolls in the final pass of the cold rolling and applying dry rolling. Regarding No. 2, the rolling temperature was set to 300° C., and the microroughness was further changed. Test pieces of 280 mm×30 mm were collected from the obtained product sheet, and direct-current magnetic measurement was performed by Epstein testing to measure hysteresis loss Wh_{10/400} with Bm=1.0 T and f=400 Hz. Moreover, after removing the insulating coating of the product sheet by boiled alkali, surface shape measurement for 100 μm×100 μm was conducted with an accelerating voltage of 5 kV using 3D-SEM (ERA-8800FE) made by Elionix Inc., and the arithmetic mean roughness Ra of the steel substrate surface at cutoff wavelength λc=20 μm was measured under the aforementioned condition. The arithmetic mean roughness Ra of the roll surface in the final pass of the cold rolling was measured by the same method. Further, the arithmetic mean roughness Ra of the steel substrate surface was measured at a scan rate of 0.5 mm/s and a cutoff wavelength of 0.8 mm using a stylus-type roughness meter of 2 μm in stylus tip radius (made by Tokyo Seimitsu Co., Ltd.).

The results are shown in Table 1. The results indicate that hysteresis loss was low in the disclosed range. In particular, even in the case where Ra of the steel substrate surface measured by the conventional typical measurement technique with cutoff wavelength λc=0.8 mm was 0.2 μm or less, hysteresis loss was high when Ra at cutoff wavelength λc=20 μm defined in the disclosure exceeded 0.2 μm.

TABLE 1

| | | | | | | | | | | | Ra of steel | Ra of steel | | |
|---|---|---|---|---|---|---|---|---|---|---|---|---|---|---|
| | | | | | | | | | | | substrate | substrate | | |
| | | | | | | | | | | Ra of | surface | surface | | |
| | Chemical composition (mass %) | | | | | | | | | roll | (μm) | (μm) | | |
| | | | | | | | | | Other | surface | λc = | λc = | Wh_{10/400} | |
| No. | C | Si | Al | Mn | P | S | N | O | components | (μm) | 20 μm | 0.8 mm | (W/kg) | Remarks |
| 1 | 0.0017 | 3.19 | 0.31 | 0.54 | 0.02 | 0.0023 | 0.0021 | 0.0034 | | 0.34 | 0.36 | 0.41 | 6.682 | Comparative |
| | | | | | | | | | | | | | | Example |
| 2 | 0.0018 | 3.32 | 0.14 | 0.36 | 0.01 | 0.0025 | 0.0019 | 0.0023 | | 0.13 | 0.25 | 0.16 | 6.562 | Comparative |
| | | | | | | | | | | | | | | Example |
| 3 | 0.0025 | 3.24 | 0.36 | 0.32 | 0.01 | 0.0026 | 0.0023 | 0.0031 | | 0.07 | 0.08 | 0.12 | 5.216 | Example |
| 4 | 0.0034 | 3.45 | 0.51 | 0.62 | 0.02 | 0.0033 | 0.0018 | 0.0016 | Sn: 0.08 | 0.04 | 0.06 | 0.15 | 5.068 | Example |
| 5 | 0.0019 | 3.32 | 0.42 | 0.23 | 0.01 | 0.0019 | 0.0022 | 0.0024 | Sb: 0.06 | 0.05 | 0.06 | 0.13 | 5.126 | Example |
| 6 | 0.0014 | 3.18 | 0.28 | 0.56 | 0.06 | 0.0018 | 0.0017 | 0.0019 | Ca: 0.0042 | 0.07 | 0.09 | 0.18 | 5.168 | Example |
| 7 | 0.0023 | 3.42 | 0.33 | 0.42 | 0.02 | 0.0024 | 0.0021 | 0.0022 | Mg: 0.0012 | 0.10 | 0.09 | 0.11 | 5.098 | Example |
| 8 | 0.0021 | 3.37 | 0.44 | 0.38 | 0.03 | 0.0022 | 0.0016 | 0.0019 | REM: 0.0038 | 0.06 | 0.06 | 0.13 | 5.142 | Example |
| 9 | 0.0021 | 3.67 | 0.25 | 0.31 | 0.04 | 0.0026 | 0.0014 | 0.0017 | Sn: 0.06 | 0.08 | 0.09 | 0.04 | 5.042 | Example |
| | | | | | | | | | Ca: 0.0031 | | | | | |
| 10 | 0.0036 | 3.26 | 0.21 | 0.18 | 0.01 | 0.0015 | 0.0031 | 0.0012 | Cr: 6 | 0.06 | 0.07 | 0.22 | 5.246 | Example |
| 11 | 0.0042 | 3.43 | 0.68 | 0.65 | 0.01 | 0.0016 | 0.0018 | 0.0023 | Ti: 0.31 | 0.07 | 0.09 | 0.15 | 5.426 | Example |
| 12 | 0.0039 | 3.29 | 0.41 | 0.33 | 0.01 | 0.0023 | 0.0021 | 0.0026 | Nb: 0.26 | 0.11 | 0.12 | 0.16 | 5.643 | Example |
| 13 | 0.0019 | 3.59 | 0.26 | 0.35 | 0.02 | 0.0018 | 0.0012 | 0.0034 | V: 0.12 | 0.09 | 0.11 | 0.18 | 5.521 | Example |
| | | | | | | | | | Zr: 0.13 | | | | | |

### Example 3

A steel slab containing the components shown in Table 2 with the balance consisting of Fe and incidental impurities was obtained by steelmaking, heated at 1100° C. for 30 minutes, and then hot rolled into a hot rolled steel sheet. The hot rolled steel sheet was subjected to hot band annealing of 1000° C.×120 sec, cold rolled to 0.15 mm for No. 1 and to 0.17 mm for Nos. 2 to 12, and then chemically polished to 0.15 mm using a HF+H₂O₂ aqueous solution, thus obtaining a cold rolled steel sheet of 0.15 mm in sheet thickness. The obtained cold rolled steel sheet was subjected to final annealing of 1000° C.×30 sec in an atmosphere of H₂:N₂=30:70 with a dew point of −50° C., and then insulating coating was applied to obtain a product sheet.

Test pieces of 280 mm×30 mm were collected from the obtained product sheet, and direct-current magnetic measurement was performed by Epstein testing to measure hysteresis loss Wh_{10/400} with Bm=1.0 T and f=400 Hz. Moreover, after removing the insulating coating of the product sheet by boiled alkali, surface shape measurement for 100 μm×100 μm was conducted with an accelerating voltage of 5 kV using 3D-SEM (ERA-8800FE) made by Elionix Inc., and the arithmetic mean roughness Ra of the steel substrate surface at cutoff wavelength λc=20 μm was measured under the aforementioned condition. Further, the arithmetic mean roughness Ra of the steel substrate surface was measured at a scan rate of 0.5 mm/s and a cutoff wavelength of 0.8 mm using a stylus-type roughness meter of 2 μm in stylus tip radius (made by Tokyo Seimitsu Co., Ltd.).

The results are shown in Table 2. In the case of performing chemical polishing, Ra of the steel substrate surface measured by the conventional typical measurement technique with cutoff wavelength λc=0.8 mm was 0.2 μm or more, but hysteresis loss was low when Ra at cutoff wavelength λc=20 μm defined in the disclosure was 0.2 μm or less.

TABLE 2

| | | | | | | | | | | | Ra of steel | Ra of steel | | |
|---|---|---|---|---|---|---|---|---|---|---|---|---|---|---|
| | | | | | | | | | | | substrate | substrate | | |
| | | | | | | | | | | | surface | surface | | |
| | Chemical composition (mass %) | | | | | | | | | | (μm) | (μm) | | |
| | | | | | | | | | Other | Chemical | λc = | λc = | Wh_{10/400} | |
| No. | C | Si | Al | Mn | P | S | N | O | components | polishing | 20 μm | 0.8 mm | (W/kg) | Remarks |
| 1 | 0.0015 | 3.26 | 0.89 | 0.32 | 0.01 | 0.0012 | 0.0013 | 0.0021 | | Not | 0.31 | 0.36 | 6.428 | Compar- |
| | | | | | | | | | | applied | | | | ative |
| | | | | | | | | | | | | | | Example |
| 2 | 0.0013 | 3.18 | 1.03 | 0.26 | 0.02 | 0.0015 | 0.0017 | 0.0015 | | Applied | 0.06 | 0.31 | 5.126 | Example |
| 3 | 0.0023 | 3.06 | 0.93 | 0.25 | 0.01 | 0.0018 | 0.0012 | 0.0017 | Sn: 0.03 | Applied | 0.02 | 0.28 | 5.043 | Example |
| 4 | 0.0014 | 2.86 | 1.32 | 0.65 | 0.01 | 0.0005 | 0.0009 | 0.0012 | Sb: 0.09 | Applied | 0.04 | 0.34 | 5.026 | Example |
| 5 | 0.0018 | 3.26 | 0.75 | 1.32 | 0.02 | 0.0019 | 0.0011 | 0.0016 | Ca: 0.0021 | Applied | 0.06 | 0.26 | 5.044 | Example |
| 6 | 0.0016 | 3.16 | 0.87 | 0.26 | 0.01 | 0.0009 | 0.0015 | 0.0034 | Mg: 0.0008 | Applied | 0.05 | 0.29 | 5.123 | Example |
| 7 | 0.0013 | 3.06 | 0.95 | 0.76 | 0.01 | 0.0015 | 0.0023 | 0.0029 | REM: 0.0026 | Applied | 0.09 | 0.33 | 5.064 | Example |
| 8 | 0.0014 | 2.95 | 0.88 | 0.46 | 0.03 | 0.0016 | 0.0013 | 0.0019 | Sn: 0.05 | Applied | 0.07 | 0.27 | 5.033 | Example |
| | | | | | | | | | Ca: 0.0036 | | | | | |
| 9 | 0.0019 | 2.63 | 1.12 | 0.26 | 0.01 | 0.0014 | 0.0019 | 0.0016 | Cr: 5.2 | Applied | 0.03 | 0.26 | 5.213 | Example |
| 10 | 0.0026 | 3.12 | 0.65 | 0.89 | 0.01 | 0.0019 | 0.0012 | 0.0017 | Ti: 0.57 | Applied | 0.08 | 0.29 | 5.326 | Example |
| 11 | 0.0022 | 3.42 | 0.87 | 0.42 | 0.01 | 0.0011 | 0.0024 | 0.0025 | Nb: 0.46 | Applied | 0.11 | 0.32 | 5.541 | Example |
| 12 | 0.0014 | 3.22 | 0.84 | 0.72 | 0.01 | 0.0015 | 0.0014 | 0.0029 | V: 0.09 | Applied | 0.12 | 0.35 | 5.426 | Example |
| | | | | | | | | | Zr: 0.05 | | | | | |

### INDUSTRIAL APPLICABILITY

The disclosed non-oriented electrical steel sheet has iron loss reduced by reducing the microroughness of the steel substrate surface, without significantly limiting the steel components. This advantageous effect is attained by a principle different from increasing specific resistance or reducing sheet thickness. Accordingly, the use of the disclosed technique together with these techniques can further reduce iron loss.

1. A non-oriented electrical steel sheet having a chemical composition containing, in mass %:
C: 0.05% or less;
Si: 0.1% or more and 7.0% or less;
Al: 0.1% or more and 3.0% or less;
Mn: 0.03% or more and 3.0% or less;
P: 0.2% or less;
S: 0.005% or less;
N: 0.005% or less; and
O: 0.01% or less,
with the balance consisting of Fe and incidental impurities,
wherein a sheet thickness is less than 0.30 mm, and
arithmetic mean roughness Ra of a steel substrate surface at cutoff wavelength λc=20 μm is 0.2 μm or less.

2. The non-oriented electrical steel sheet according to claim 1,
wherein the chemical composition contains, in mass %, at least one group selected from:
one or more of Sn and Sb: 0.01% or more and 0.2% or less in total,
one or more of Ca, Mg, and REM: 0.0005% or more and 0.010% or less in total,
Cr: 0.1% or more and 20% or less, and
one or more of Ti, Nb, V, and Zr: 0.01% or more and 1.0% or less in total.

3. (canceled)

4. (canceled)

5. (canceled)

6. A manufacturing method of a non-oriented electrical steel sheet, comprising:
heating a steel slab having the chemical composition according to claim 1;
hot rolling the steel slab into a hot rolled steel sheet;
optionally hot band annealing the hot rolled steel sheet;
cold rolling the hot rolled steel sheet once or twice or more with intermediate annealing in between, into a cold rolled steel sheet whose sheet thickness is less than 0.30 mm; and
final annealing the cold rolled steel sheet,
wherein arithmetic mean roughness Ra of a roll surface in a final pass of last cold rolling at cutoff wavelength λc=20 μm is 0.2 μm or less.

7. A manufacturing method of a non-oriented electrical steel sheet, comprising:
heating a steel slab having the chemical composition according to claim 2;
hot rolling the steel slab into a hot rolled steel sheet;
optionally hot band annealing the hot rolled steel sheet;
cold rolling the hot rolled steel sheet once or twice or more with intermediate annealing in between, into a cold rolled steel sheet whose sheet thickness is less than 0.30 mm; and
final annealing the cold rolled steel sheet,
wherein arithmetic mean roughness Ra of a roll surface in a final pass of last cold rolling at cutoff wavelength λc=20 μm is 0.2 μm or less.
